(19) United States
(12) Patent Application Publication
(10) Pub. No.: US 2025/0132326 A1
(43) Pub. Date: Apr. 24, 2025

(54) CATHODE ACTIVE MATERIAL, LITHIUM ION SECONDARY BATTERY, AND METHOD FOR PRODUCING CATHODE ACTIVE MATERIAL

(71) Applicant: TOYOTA JIDOSHA KABUSHIKI KAISHA, Toyota-shi (JP)

(72) Inventor: Takahiko NINOMIYA, Miyoshi-shi (JP)

(73) Assignee: TOYOTA JIDOSHA KABUSHIKI KAISHA, Toyota-shi (JP)

(21) Appl. No.: 18/749,688

(22) Filed: Jun. 21, 2024

(30) Foreign Application Priority Data
Oct. 24, 2023 (JP) 2023-182594

(51) Int. Cl. H01M 4/525; C01G 53/44; H01M 4/36; H01M 10/0525

(52) U.S. Cl. CPC H01M 4/525; C01G 53/44; H01M 4/366; H01M 10/0525; C01P 2002/50; C01P 2006/40

(57) ABSTRACT

A cathode active material includes a crystal structure including an alternate arrangement of transition metal layers and lithium layers. The transition metal layers include at least one kind of transition metal selected from nickel, cobalt and manganese. In the cathode active material, a stoichiometric oxygen content is 1.9 or more.

### CROSS-REFERENCE TO RELATED APPLICATION

This application claims priority to Japanese Patent Application No. 2023-182594 filed on Oct. 24, 2023, incorporated herein by reference in its entirety.

### BACKGROUND

### 1. Technical Field

The present disclosure relates to a cathode active material, a lithium ion secondary battery, and a method for producing the cathode active material.

### 2. Description of Related Art

A lithium-transition metal composite oxide having a crystal structure in which transition metal layers having an octahedral structure composed of transition metal atoms and oxygen atoms and lithium layers are arranged alternately is widely used as a cathode active material of a lithium ion secondary battery.

The lithium-transition metal composite oxide is produced by firing a raw material containing a transition metal and lithium in an atmosphere containing oxygen. The condition for firing the raw material may affect the properties of the lithium-transition metal composite oxide obtained after firing.

Japanese Unexamined Patent Application Publication No. 2018-193296 (JP 2018-193296 A) describes the following method for suppressing precipitation of a lithium component on the surface of an obtained particle. The raw material of the lithium-transition metal composite oxide is fired under a condition that an oxygen partial pressure in a temperature range of 450° C. or more and 650° C. or less is 500 hPa or more and 1013.25 hPa or less (i.e., 0.5 atm or more and 1.0 atm or less).

### SUMMARY

The lithium ion secondary battery using the lithium-transition metal composite oxide as the cathode active material has room for improvement in initial capacity. The present disclosure provides a cathode active material with which a lithium ion secondary battery having an improved initial capacity is obtained, a lithium ion secondary battery including a cathode including the cathode active material, and a method for producing the cathode active material with which the lithium ion secondary battery having an improved initial capacity is obtained.

The means for addressing the above issue includes the following aspects.
(1) A cathode active material including a crystal structure including an alternate arrangement of:
transition metal layers containing at least one kind of transition metal selected from among nickel, cobalt, and manganese; and
lithium layers, in which
a stoichiometric oxygen content is 1.9 or more.
(2) A lithium ion secondary battery including
a cathode including the cathode active material according to (1).
(3) A method for producing a cathode active material, the method including
a step of firing, in an atmosphere containing oxygen, a raw material of the cathode active material containing lithium and at least one kind of transition metal selected from among nickel, cobalt, and manganese, in which
an oxygen partial pressure of the atmosphere is 1.1 atm or more.
(4) The method according to (3), in which
the oxygen partial pressure is 6.0 atm or less.
(5) The method according to (3), in which
the oxygen partial pressure is 1.5 atm or more and 3.0 atm or less.

The embodiment of the present disclosure provides the cathode active material with which the lithium ion secondary battery having an improved initial capacity is obtained, the lithium ion secondary battery including the cathode including the cathode active material, and the method for producing the cathode active material with which the lithium ion secondary battery having an improved initial capacity is obtained.

### DETAILED DESCRIPTION OF EMBODIMENTS

In the present disclosure, a numerical range indicated by using “to” means a range including numerical values described before and after “to” as a minimum value and a maximum value, respectively.

In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples.
In the present disclosure, the term “step” is included in the term as long as the intended purpose of the step is achieved, even if it is not clearly distinguishable from other steps as well as independent steps.
In the present disclosure, a combination of two or more preferred embodiments is a more preferred embodiment.
In the present disclosure, the amount of each component means the total amount of a plurality of substances unless otherwise specified, when a plurality of substances corresponding to each component are present.

### Cathode Active Material

The cathode active material of the present disclosure includes:
a transition metal layer comprising at least one transition metal selected from nickel, cobalt, and manganese;
the lithium layer has a crystal structure in which the lithium layers are alternately arranged; and
the stoichiometric oxygen content is 1.9 or more.

The cathode active material of the present disclosure is a compound belonging to a lithium transition metal complex oxide having a crystal structure (also referred to as a layered stacked structure or a R-3m type crystal structure) in which transition metal layers and lithium layers are alternately arranged. Transition metal layers include octahedral structures composed of transition metal atoms and oxygen-atoms.

In the present disclosure, the lithium transition metal composite oxide means a composite oxide including lithium and one or more transition metals.

As shown in the examples below, a lithium ion secondary battery including a positive electrode including a cathode active material in which a stoichiometric oxygen content is 1.9 or more exhibits a better initial-capacity than a lithium ion secondary battery including a positive electrode including a cathode active material in which a stoichiometric oxygen content is less than 1.9. The reason for this is inferred as follows, for example. However, the present disclosure is not limited by the following inference.

A lithium transition metal composite oxide, which is a composite oxide of lithium and a transition metal, is represented by a compositional equation of LiMeO₂ (Me represents a transition metal). Since the valence of lithium is ±1 and the valence of oxygen is −2, the theoretical valence of the transition metal is ±3.

However, a lithium transition metal composite oxide obtained by actually calcining a raw material containing a transition metal and lithium contains oxygen defects generated during calcination (i.e., the theoretical stoichiometric oxygen amount is less than 2.0), Me³⁺ and Me²⁺ are mixed in the transition metal layers.
When the ratio of Me²⁺ to the entire transition metal constituting the transition metal layer is large, the octahedral structure composed of the transition metal atom and the oxygen atom is distorted, and this distortion is a factor preventing the lithium ion from being inserted between the transition metal layers.
The cathode active material of the present disclosure has a stoichiometric oxygen content of 1.9 or more. Therefore, the ratio of Me²⁺ to the entire transition metal constituting the transition metal layer is small, and the octahedral structure composed of the transition metal atom and the oxygen atom is stabilized. As a result, the lithium ion is better inserted between the transition metal layers, and the initial capacity of the battery is improved.

The cathode active material of the present disclosure is not particularly limited as long as it contains at least one selected from nickel, cobalt, and manganese as the transition metal.

In an embodiment, the cathode active material preferably contains at least nickel as the transition metal, more preferably nickel and at least one selected from cobalt and manganese, and still more preferably containing nickel, cobalt, and manganese (NCM, nickel cobalt manganese oxide).
NCM may contain a high proportion of Ni (e.g., 70 mol % or more of the total transition-metal).

The molar ratio of NCM to Ni, Co and Mn may be selected, for example, from the range of a molar ratio (Ni:Co) of Ni to Co of 1:0.1 to 1:1, and the molar ratio (Ni:Mn) of Ni to Mn of 1:0.1 to 1:1.

The molar ratio (Ni:Co) of Ni to Co may be selected from 1:0.1 to 1:0.5, 1:0.1 to 1:0.3, or 1:0.1 to 1:0.2.

The molar ratio (Ni:Mn) of Ni to Mn may be selected from 1:0.1 to 1:0.5, 1:0.1 to 1:0.3, or 1:0.1 to 1:0.2.

The cathode active material may include a transition-metal selected from lithium, oxygen, and Ni, Co, and Mn, or may include elements other than these (hereinafter referred to as other elements). Specific examples of the other element include Al, B, Mg, Ti, V, Cr, Fe, Cu, Zn, Ga, Sr, Zr, Nb, In, Sn, Ta, W, La, B, Ru, Cd, Ag, Y, Sc, As, Sb, Pt, Au, and Si.

When the cathode active material of the present disclosure contains other elements, the proportion thereof may be 10 mol % or less, 5 mol % or less, or 1 mol % or less of the entire cathode active material.
When the cathode active material of the present disclosure contains other elements, the proportion thereof may be 0.001 mol % or more, 0.01 mol % or more, or 0.1 mol % or more of the entire cathode active material.

The stoichiometric oxygen content of the cathode active material of the present disclosure is 1.9 or more.

From the viewpoint of the initial capacity of the battery, the stoichiometric oxygen content of the cathode active material is preferably 1.92 or more, more preferably 1.94 or more, and even more preferably 1.96 or more.
The stoichiometric oxygen content of the cathode active material may be 2.0, less than 2.0, 1.99 or less, or 1.985 or less.
The stoichiometric oxygen content of the cathode active material can be adjusted by, for example, conditions at the time of firing the raw material of the cathode active material. Specific examples of conditions for firing the raw material of the cathode active material include oxygen partial pressure in a firing atmosphere.

In the present disclosure, the stoichiometric oxygen content of the cathode active material is measured by an iodometric titration method.

The cathode active material may be in particulate form. The volume average particle diameter of the cathode active material in a particulate form is not particularly limited, and can be selected from, for example, a range of 5 μm to 30 μm. When the cathode active material is a secondary particle that is an aggregate of a plurality of primary particles, the volume average particle diameter is the volume average particle diameter of the secondary particles.

The volume average particle diameter of the cathode active material particles is not particularly limited, and can be selected from, for example, a range of 5 μm to 30 μm.

The volume-average particle size of the particles is the particle size (D50) when the cumulative volume is 50% in the volume-based particle size distribution. The volume-based particle size distribution is obtained, for example, by a laser diffraction and scattering method.

### Lithium Ion Secondary Battery

The lithium ion secondary battery of the present disclosure includes a positive electrode including the above-described cathode active material.

The positive electrode includes, for example, a current collector and a positive electrode layer disposed on the current collector, and the positive electrode layer includes the cathode active material of the present disclosure.
The positive electrode layer may be disposed on one side or both sides of the current collector.

Examples of the material constituting the current collector of the positive electrode include aluminum, an aluminum alloy, nickel, titanium, and stainless steel. Examples of the shape of the current collector include a foil and a mesh.

The positive electrode layer is disposed on the current collector by, for example, applying a slurry-like positive electrode material to one or both surfaces of the current collector. If necessary, a pressure treatment for adjusting the density of the positive electrode layer may be performed. The thickness of the positive electrode layer is not particularly limited, and can be selected from, for example, a range of 10 μm to 100 μm.

The positive electrode material may be in a state of a mixture containing components other than the cathode active material, such as a conductive aid and a binder. If desired, a solvent may be added to the mixture to adjust the viscosity of the mixture.

Specific examples of the conductive aid include carbon materials such as carbon black (acetylene black, thermal black, furnace black, and the like), carbon nanotubes, and graphite.

The conductive material contained in the positive electrode material may be one kind alone or two or more kinds thereof.

Specific examples of the binder include polyvinylidene fluoride (PVDF), polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, and polymethacrylate.

The binder contained in the positive electrode material may be one kind alone or two or more kinds thereof.

The lithium ion secondary battery of the present disclosure includes, for example, a positive electrode, a negative electrode, and an electrolyte.

The negative electrode includes, for example, a current collector and a negative electrode layer disposed on the current collector and including a negative electrode active material. Examples of the negative electrode active material include carbon materials such as graphite, hard carbon, soft carbon, and activated carbon, silicon, metallic lithium, lithium alloy, and lithium titanate (LTO).
Examples of the material constituting the current collector of the negative electrode include copper, a copper alloy, nickel, titanium, and stainless steel. Examples of the shape of the current collector of the negative electrode include a foil and a mesh.

The electrolyte may be either a liquid or a solid. As the liquid electrolyte (electrolyte solution), a solution obtained by dissolving a known electrolyte such as LiPF₆ in an organic solvent can be used without any particular limitation.

Specific examples of the organic solvents include cyclic or linear carbonates such as ethylene carbonate (EC), dimethyl carbonate (DMC), diethyl carbonate (DEC), and ethyl methyl carbonate (EMC). The solvent may be a mixture of two or more solvents or a mixture comprising a cyclic carbonate and a linear carbonate.
Solvents may include additives such as vinylene carbonate (VC).
As the solid electrolyte, a known solid electrolyte such as a sulfide solid electrolyte, an oxide solid electrolyte, or a halide solid electrolyte can be used without any particular limitation.

The lithium ion secondary battery may include a separator disposed between the positive electrode and the negative electrode. Examples of the separator include a nonwoven fabric, a cloth, and a microporous film containing a polyolefin as a main component, such as polyethylene and polypropylene.

### Method for Producing Cathode Active Material

A method for producing a cathode active material according to the present disclosure includes:
a step of firing a raw material of a cathode active material containing at least one transition metal selected from nickel, cobalt and manganese and lithium in an atmosphere containing oxygen (hereinafter, also referred to as a firing step).
   The oxygen partial pressure of the atmosphere is 1.1 atm or higher.

As shown in the examples described below, the lithium ion secondary battery including a positive electrode including a cathode active material from the calcination step performed in an atmosphere having a 1.1 atm or higher oxygen partial pressure exhibits a better initial-capacity than a lithium ion secondary battery including a positive electrode including a cathode active material from the calcination step performed in an atmosphere having an oxygen partial pressure that is less than 1.1 atm. The reason for this is inferred as follows, for example. However, the present disclosure is not limited by the following inference.

Batteries using a cathode active material obtained by carrying out the calcination process in an atmosphere having an oxygen partial pressure of 1.1 atm or higher have a larger stoichiometric oxygen content than a cathode active material obtained by carrying out the calcination process in an atmosphere having an oxygen partial pressure less than 1.1 atm.

That is, by carrying out the calcination step in an atmosphere having an oxygen partial pressure of 1.1 atm or more, the amount of oxygen defects generated during firing is reduced, and the octahedral structure composed of transition metal atoms and oxygen atoms constituting the transition metal layer is stabilized. As a result, the lithium ion is better inserted between the transition metal layers, and the initial capacity of the battery is improved.

The oxygen partial pressure in the atmosphere in which the calcination step is performed is not particularly limited as long as it is equal to or higher than 1.1 atm, but as shown in Examples to be described later, the stoichiometric oxygen content tends to increase with an increase in the oxygen partial pressure. Therefore, the oxygen partial pressure of the atmosphere in which the firing step is performed may be 1.5 atm or higher, 2.0 atm or higher, or 2.5 atm or higher.

The upper limit value of the oxygen partial pressure of the atmosphere in which the firing step is performed is not particularly limited, but as shown in Examples to be described later, an increase in the stoichiometric oxygen amount with an increase in the oxygen partial pressure tends to decrease gradually.

Therefore, the oxygen partial pressure of the atmosphere in which the firing step is performed may be 6.0 atm or less, 5.0 atm or less, or 3.0 atm or less.

From the viewpoint of a balance between an increase in the stoichiometric oxygen amount of the cathode active material and economic efficiency, the oxygen partial pressure of the atmosphere in which the firing step is performed may be within the range from 1.5 atm or higher to 3.0 atm or lower.

The oxygen partial pressure in the atmosphere in which the firing step is performed may be constant or changed from the start to the end of the firing step. The calcination step may have or need not have a duration in which an oxygen partial pressure is less than 1.1 atm.

The oxygen partial pressure of the firing atmosphere of the raw material of the cathode active material can be adjusted by, for example, operation of a valve of an apparatus used for firing.

The oxygen content in the atmosphere in which the calcination step is carried out may be selected, for example, from the range of 60% by volume to 100% by volume.

The temperature at which the firing step is performed is not particularly limited, and can be selected from known firing conditions. The temperature of the calcination may be selected from the range of 600° C. to 850° C., for example.

From the viewpoint of obtaining a cathode active material having a sufficiently large stoichiometric oxygen content under an appropriate firing condition, the firing temperature is preferably less than 750° C., more preferably 730° C. or less, and still more preferably 720°° C. or less.
The temperature at which the firing step is performed may be constant or varied from the start to the end of the firing step.

The raw material of the cathode active material to be fired in the firing step is not particularly limited, and can be selected from known raw materials.

In an embodiment, the raw material of the cathode active material may be a mixture containing a compound containing at least one selected from nickel, cobalt, and manganese (hydroxide, carbonate, and the like) and a compound containing lithium (hydroxide, carbonate, and the like).

The cathode active material produced by the method of the present disclosure may be the cathode active material of the present disclosure described above. That is, details and preferred aspects of the cathode active material produced by the method of the present disclosure may be the same as details and preferred aspects of the cathode active material of the present disclosure described above.

Hereinafter, the present disclosure will be described in more detail with reference to Examples, but the disclosure of the present disclosure is not limited to these Examples.

### Preparation of Cathode Active Material

NiSO_{4,} CoSO₄ and MnSO₄ were dissolved in ion-exchanged water to obtain a raw material solution having a density of 30 wt %. The molar ratios of Ni, Co and Mn in the raw material dissolving solution were as shown in Table 1.

An aqueous solution of NH₃ was charged into the reactor, and nitrogen-substituted with stirring. NaOH was then added to the reactor to make the aqueous solution alkaline.

The raw material solution and NH₃ were added dropwise to precipitate Ni, Co and Mn hydroxides while controlling pH in the reactor to be constant. The resulting precipitate was removed by filtration and dispersed in ion-exchanged water. The hydroxide dispersed in the ion-exchanged water was filtered and dried at 120° C. for 16 hours to remove moisture, thereby obtaining a transition metal hydroxide as a precursor of the cathode active material.

Lithium hydroxide was added to the obtained precursor and mixed to obtain a raw material of the cathode active material. The amount of lithium hydroxide was adjusted so that the amount of lithium per mole sum of the transition-metals (Ni, Co, and Mn) in the precursors was 1 mole.

The raw material of the cathode active material was fired in a pressurized firing furnace into which oxygen gas was introduced at 700° C. for 10 hours to obtain the cathode active materials of Comparative Example 1 and Examples 1 to 5. Firing was performed by adjusting the oxygen partial pressure in the firing furnace to the values shown in Table 1.

The stoichiometric oxygen content of the obtained cathode active material was measured by iodometric titration. The results are shown in Table 1.

### Evaluation of Battery Initial Capacity

A cathode active material (88 parts by mass), acetylene black (10 parts by mass) as a conductive material, and polyvinylidene fluoride (2 parts by mass) as a binder were mixed, and the viscosity was adjusted with a solvent to obtain a positive electrode mixture. The positive electrode mixture was coated on an aluminum foil and dried at 80° C. for 5 minutes to obtain a positive electrode.

A laminate type evaluation battery was produced using the obtained positive electrode, separator (polyethylene microporous film), and an electrode body formed by laminating negative electrodes containing graphite as an active material in this order, and an electrolytic solution. As the electrolyte solution, ethylene carbonate (EC) in which LiPF₆ (concentration: 1 M) was dissolved, DMC and EMC mixed solvents (the volume ratio of EC/DMC/EMC was 3/4/3) were used.
The discharge capacity of CCCV charge (1.5 to 4.1 V) was measured with 0.1 C current to obtain the initial capacity of the evaluation-use cell. Table 1 shows the initial capacities of Examples 1 to 5 indexed using the initial capacity measured using the cathode active material of Comparative Example 1 as a reference value (100).

TABLE 1

| | | | | Partial | | |
|---|---|---|---|---|---|---|
| | | | | pressure | Stoichiometric | |
| | Ratio [mol %] | | | of oxygen | oxygen | Initial |
| | Ni | Co | Mn | [atm] | content | capacity |
| Comparative | 0.8 | 0.1 | 0.1 | 1.0 | 1.889 | 100 |
| Example 1 | | | | | | |
| Example 1 | 0.8 | 0.1 | 0.1 | 1.1 | 1.952 | 103 |
| Example 2 | 0.8 | 0.1 | 0.1 | 1.5 | 1.962 | 104 |
| Example 3 | 0.8 | 0.1 | 0.1 | 2.5 | 1.980 | 108 |
| Example 4 | 0.8 | 0.1 | 0.1 | 6.0 | 1.982 | 109 |
| Example 5 | 0.8 | 0.1 | 0.1 | 7.0 | 1.980 | 107 |

As shown in Table 1, the initial capacity of the battery obtained using the cathode active materials of Examples 1 to 5 in which the stoichiometric oxygen content is 1.9 or more is larger than the initial capacity of the battery obtained using the cathode active material of Comparative Example 1 in which the stoichiometric oxygen content is less than 1.9. The above results suggest that the stoichiometric oxygen content of the cathode active material is a factor involved in the initial capacity of the battery.

Further, the stoichiometric oxygen content of the cathode active materials of Examples 1 to 5 obtained in the atmosphere for firing the raw material with the oxygen partial pressure of 1.1 atm or higher is larger than the stoichiometric oxygen content of the cathode active material of Comparative Example 1 obtained in the atmosphere for firing the raw material with the oxygen partial pressure of 1.0 atm. These results show that setting the oxygen partial pressure in the atmosphere in which the raw material of the cathode active material is fired to be 1.1 atm or higher reduces the oxygen deficiency in the cathode active material and increases the stoichiometric oxygen content of the cathode active material.

What is claimed is:

1. A cathode active material comprising a crystal structure including an alternate arrangement of:
transition metal layers containing at least one kind of transition metal selected from among nickel, cobalt, and manganese; and
lithium layers, wherein a stoichiometric oxygen content is 1.9 or more.

2. A lithium ion secondary battery comprising a cathode including the cathode active material according to claim 1.

3. A method for producing a cathode active material, the method comprising a step of firing, in an atmosphere containing oxygen, a raw material of the cathode active material containing lithium and at least one kind of transition metal selected from among nickel, cobalt, and manganese, wherein an oxygen partial pressure of the atmosphere is 1.1 atm or more.

4. The method according to claim 3, wherein the oxygen partial pressure is 6.0 atm or less.

5. The method according to claim 3, wherein the oxygen partial pressure is 1.5 atm or more and 3.0 atm or less.
